(19) United States
(12) Patent Application Publication
(10) Pub. No.: US 2018/0053434 A1
(43) Pub. Date: Feb. 22, 2018

(54) METHOD, SYSTEM AND NON-TRANSITORY COMPUTER-READABLE RECORDING MEDIUM FOR ASSISTING LEARNING

(71) Applicant: Sang Duck Choi, Seoul (KR)

(72) Inventor: Sang Duck Choi, Seoul (KR)

(21) Appl. No.: 15/683,198

(22) Filed: Aug. 22, 2017

(30) Foreign Application Priority Data
Aug. 22, 2016 (KR) 10-2016-0106403

(51) Int. Cl. G09B 5/12; G09B 5/06; G06Q 40/02

(52) U.S. Cl. CPC G09B 5/12; H04L 67/12; G06Q 40/02; G09B 5/065

(57) ABSTRACT

The present invention relates to a method, system and non-transitory computer-readable recording medium for assisting learning. According to one aspect of the invention, there is provided a method for assisting learning, comprising the steps of: determining an evaluation index for a teacher with reference to at least one of information on an expression of respect of at least one other teacher that is made for the teacher or know-how contents owned by the teacher, and information on a status of the teacher about acquirement of know-how contents owned by at least one other teacher; and determining a reward or teaching condition applied to the teacher, based on the determined evaluation index.

### CROSS-REFERENCE TO RELATED APPLICATIONS

This application claims priority to Korean Patent Application No. 10-2016-0106403 filed on Aug. 22, 2016, the entire contents of which are hereby incorporated by reference.

### FIELD OF THE INVENTION

The present invention relates to a method, system and non-transitory computer-readable recording medium for assisting learning.

### BACKGROUND

It is very important in the field of learning to accurately evaluate teaching ability of teachers who teach knowledge to learners. In learning assistance services that have been introduced so far, the teaching ability of teachers has been evaluated indirectly based on their academic backgrounds, majors, certificates related to specialized knowledge and the like, or evaluated subjectively based on feedback from learners. However, it is difficult to accurately evaluate the teaching ability of teachers by means of the conventional services, because the ability to acquire knowledge belongs to a clearly different level from the ability to deliver knowledge, and it is not appropriate to determine the teaching ability to deliver knowledge depending on the subjective evaluation of learners who do not properly understand the knowledge.

For example, there are over 400 million people worldwide who speak English as their native language, but not all of them currently have the ability to teach English. However, many of them have considerable experience and depth of knowledge of English, so they may have no difficulty in becoming proficient English teachers if they have know-how or preparation required for English teaching.

Further, it is also very important in the learning assistance services to manage teaching ability of teachers and learning ability of learners at appropriate levels, and to give motivation such that they continuously develop their own ability. Learning motivation will be reduced if a learner is dissatisfied with teaching ability of a teacher that the learner has experienced, and distrust of the learning assistance services will arise if the learner experiences such unsatisfactory situations several times. Since it is general that a learner is anxious about how much effort is required to achieve a desired level of ability, such negative experiences may increase the anxiety of the learner, and may consequently reduce learning motivation of the learner and cause the learner to leave the learning assistance services. For this reason, many learners rely on and pay a lot of money for learning assistance services provided by academies with somewhat trustworthy and famous brands.

Meanwhile, according to the conventional learning assistance services, attempts are made to motivate teachers or learners in a manner not substantially improving the ability of the teachers or learners. For example, there may be attempts of teachers to make seemingly spectacular appearances or rhetoric rather than to develop their teaching ability, attempts to provide indiscreet monetary rewards to teachers or learners, or attempts to give negative stimuli such as physical punishment to learners. These attempts make it difficult to substantially improve the ability of teachers or learners, or to give a true sense of motivation. Particularly, the above problems may be further exacerbated in an online learning environment in which it is difficult for operators to directly manage and motivate all teachers and learners.

Accordingly, the inventor(s) have developed a technique to accurately evaluate the teaching ability of teachers while assisting the teachers to effectively improve their teaching ability, and to give proper motivation to both teachers and learners.

### SUMMARY OF THE INVENTION

One object of the present invention is to solve all the above-described problems in the prior art.

Another object of the invention is to accurately evaluate teaching ability of teachers while assisting the teachers to effectively improve their teaching ability, and to give proper motivation to both teachers and learners, by determining a first evaluation index (e.g., a level of recognition) for a teacher with reference to information on an expression of respect of at least one other teacher that is made for the teacher or know-how contents owned by the teacher, and determining a second evaluation index (e.g., a level of lecture preparation) for the teacher with reference to information on a status of the teacher about acquirement of know-how contents owned by at least one other teacher; and determining a reward or teaching condition applied to the above teacher, based on at least one of the first and second evaluation indexes determined as above.

The representative configurations of the invention to achieve the above objects are described below.

According to one aspect of the invention, there is provided a method for assisting learning, comprising the steps of: determining an evaluation index for a teacher with reference to at least one of information on an expression of respect of at least one other teacher that is made for the teacher or know-how contents owned by the teacher, and information on a status of the teacher about acquirement of know-how contents owned by at least one other teacher; and determining a reward or teaching condition applied to the teacher, based on the determined evaluation index.

According to another aspect of the invention, there is provided a system for assisting learning, comprising: a teacher management unit configured to determine an evaluation index for a teacher with reference to at least one of information on an expression of respect of at least one other teacher that is made for the teacher or know-how contents owned by the teacher, and information on a status of the teacher about acquirement of know-how contents owned by at least one other teacher; and a reward management unit configured to determine a reward or teaching condition applied to the teacher, based on the determined evaluation index.

In addition, there are further provided other methods and systems to implement the invention, as well as non-transitory computer-readable recording media having stored thereon computer programs for executing the methods.

According to the invention, it is possible to accurately evaluate teaching ability of teachers and assist the teachers to effectively improve their teaching ability.

According to the invention, it is possible to give proper motivation to learners as well as teachers.

According to the invention, it is possible to utilize a sponsorship between a teacher and a learner in a poor learning condition as a means for giving long-term motivation to the learner.

### BRIEF DESCRIPTION OF THE DRAWINGS

FIG. 1 schematically shows the configuration of an entire system for assisting learning according to one embodiment of the invention.

FIG. 2 illustratively shows the internal configuration of a learning assistance system according to one embodiment of the invention.

FIG. 3 illustratively shows relationships that may be formed between teachers or between learners and teachers according to one embodiment of the invention.

### DETAILED DESCRIPTION

In the following detailed description of the present invention, references are made to the accompanying drawings that show, by way of illustration, specific embodiments in which the invention may be practiced. These embodiments are described in sufficient detail to enable those skilled in the art to practice the invention. It is to be understood that the various embodiments of the invention, although different from each other, are not necessarily mutually exclusive. For example, specific shapes, structures and characteristics described herein may be implemented as modified from one embodiment to another without departing from the spirit and scope of the invention. Furthermore, it shall be understood that the locations or arrangements of individual elements within each of the embodiments may also be modified without departing from the spirit and scope of the invention. Therefore, the following detailed description is not to be taken in a limiting sense, and the scope of the invention is to be taken as encompassing the scope of the appended claims and all equivalents thereof. In the drawings, like reference numerals refer to the same or similar elements throughout the several views.

Hereinafter, various preferred embodiments of the present invention will be described in detail with reference to the accompanying drawings to enable those skilled in the art to easily implement the invention.

Configuration of the Entire System

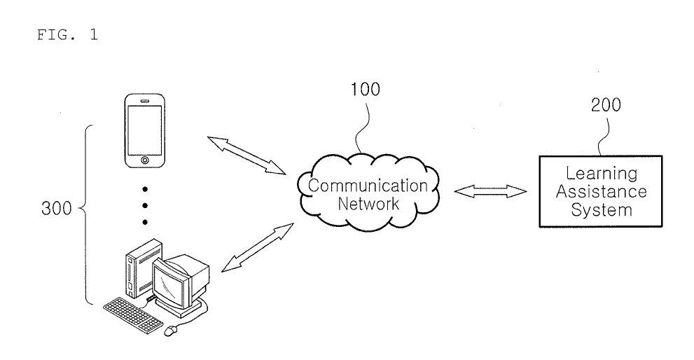

FIG. 1 schematically shows the configuration of the entire system for assisting learning according to one embodiment of the invention.

As shown in FIG. 1, the entire system according to one embodiment of the invention may comprise a communication network 100, a learning assistance system 200, and a user device 300.

First, the communication network 100 according to one embodiment of the invention may be implemented regardless of communication modality such as wired and wireless communications, and may be constructed from a variety of communication networks such as local area networks (LANs), metropolitan area networks (MANs), and wide area networks (WANs). Preferably, the communication network 100 described herein may be the Internet or the World Wide Web (WWW). However, the communication network 100 is not necessarily limited thereto, and may at least partially include known wired/wireless data communication networks, known telephone networks, or known wired/wireless television communication networks.

Next, the learning assistance system 200 according to one embodiment of the invention may function to accurately evaluate teaching ability of teachers while assisting the teachers to effectively improve their teaching ability, and to give proper motivation to both teachers and learners, by determining a first evaluation index (e.g., a level of recognition) for a teacher with reference to information on an expression of respect of at least one other teacher that is made for the teacher or know-how contents owned by the teacher, and determining a second evaluation index (e.g., a level of lecture preparation) for the teacher with reference to information on a status of the teacher about acquirement of know-how contents owned by at least one other teacher; and determining a reward or teaching condition applied to the above teacher, based on at least one of the first and second evaluation indexes determined as above.

The configuration and function of the learning assistance system 200 according to the invention will be discussed in more detail below.

Next, the user device 300 according to one embodiment of the invention is digital equipment that may function to allow a user (teacher or learner) to connect to and then communicate with the learning assistance system 200, and any type of digital equipment having a memory means and a microprocessor for computing capabilities, such as a smart phone, a tablet, a smart watch, a smart band, smart glasses, a desktop computer, a notebook computer, a workstation, a personal digital assistant (PDA), a web pad, and a mobile phone, may be adopted as the user device 300 according to the invention.

Particularly, the user device 300 may include an application (not shown) to assist a user (teacher or learner) to receive learning assistance services according to the invention from the learning assistance system 200. The application may be downloaded from the learning assistance system 200 or a known web server (not shown).

Configuration of the Learning Assistance System

Hereinafter, the internal configuration of the learning assistance system 200 crucial for implementing the invention and the functions of the respective components thereof will be discussed.

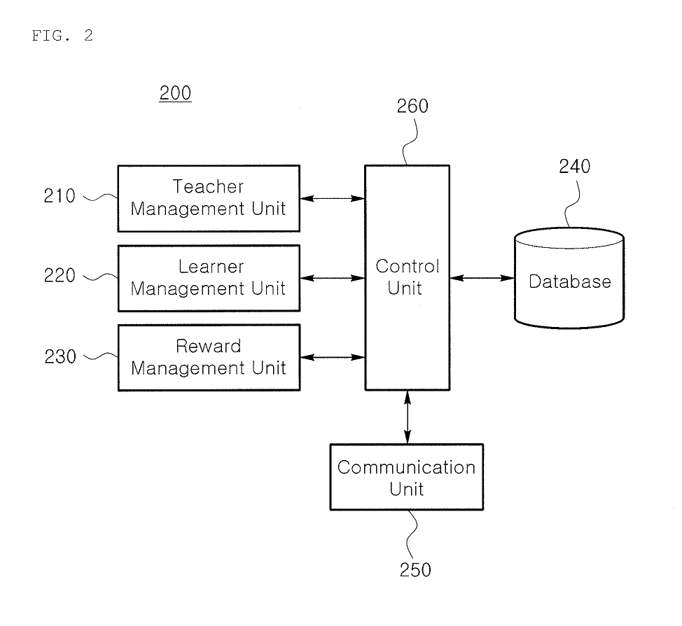

FIG. 2 illustratively shows the internal configuration of the learning assistance system according to one embodiment of the invention.

Referring to FIG. 2, the learning assistance system 200 according to one embodiment of the invention may comprise a teacher management unit 210, a learner management unit 220, a reward management unit 230, a database 240, a communication unit 250, and a control unit 260. According to one embodiment of the invention, at least some of the teacher management unit 210, the learner management unit 220, the reward management unit 230, the database 240, the communication unit 250, and the control unit 260 may be program modules to communicate with an external system (not shown). The program modules may be included in the learning assistance system 200 in the form of operating systems, application program modules and other program modules, while they may be physically stored in a variety of commonly known storage devices. Further, the program modules may also be stored in a remote storage device that may communicate with the learning assistance system 200. Meanwhile, such program modules may include, but not limited to, routines, subroutines, programs, objects, components, data structures and the like for performing specific tasks or executing specific abstract data types as will be described below in accordance with the invention.

First, according to one embodiment of the invention, the teacher management unit 210 may function to determine an evaluation index for a teacher with reference to at least one of information on an expression of respect of at least one other teacher that is made for the teacher or know-how contents owned by the teacher, and information on a status of the teacher about acquirement of know-how contents owned by at least one other teacher.

Specifically, according to one embodiment of the invention, the teacher management unit 210 may function to determine a first evaluation index for a teacher with reference to information on an expression of respect of at least one other teacher that is made for the teacher or know-how contents owned by the teacher. Here, the know-how contents owned by the teacher may include video contents obtained by recording the teacher's lectures, audio contents obtained by recording the teacher's lectures, lecture notes of the teacher, memo contents created by the teacher, contents about a learning status of a learner supported by the teacher through a sponsorship (e.g., the learner's progress cases, academic achievement, etc.), contents about feedback provided by the teacher to lectures of other teachers, and the like. Here, according to one embodiment of the invention, the first evaluation index determined for the teacher may be an extrinsic evaluation index determined based on expressions of respect of other teachers for the teacher or the know-how contents of the teacher, and may be referred to as a level of recognition, for example.

For example, the teacher management unit 210 according to one embodiment of the invention may increase a first evaluation index for a first teacher in response to a second teacher's expression of respect for know-how contents owned by the first teacher, and the first teacher may be given a rating of “respected teacher”, “well-respected teacher”, “highly-respected teacher” or the like according to the first evaluation index for the teacher. Here, the teacher management unit 210 according to one embodiment of the invention may assist the first teacher to provide feedback to the second teacher or lectures of the second teacher (i.e., feedback that may be helpful to the second teacher) in return for the second teacher's expression of respect for the first teacher.

Further, according to one embodiment of the invention, the teacher management unit 210 may function to determine a second evaluation index for the teacher with reference to information on a status of the teacher about acquirement of know-how contents owned by and provided from at least one other teacher. Here, according to one embodiment of the invention, the second evaluation index determined for the teacher may be an intrinsic evaluation index determined based on a level at which the teacher has acquired know-how required for lectures, and may be referred to as a level of lecture preparation, for example.

For example, a second evaluation index for a second teacher may be increased in response to the second teacher's acquirement of know-how contents owned by a first teacher, and the second teacher may be given a rating of “equipped teacher”, “well-equipped teacher”, “highly-equipped teacher” or the like according to the second evaluation index for the teacher.

Meanwhile, according to one embodiment of the invention, the teacher management unit 210 may function to open information on a first or second evaluation index for a teacher to learners or other teachers.

Meanwhile, according to one embodiment of the invention, the first or second evaluation index for a teacher determined as above may be subdivided by learning fields. For example, the first and second evaluation indexes for a teacher may be determined with respect to each of the detailed learning fields such as grammar, pronunciation, communication, and the like.

Meanwhile, according to one embodiment of the invention, the first or second evaluation index for a teacher may be determined with further reference to information on the teacher's reputation obtained from learners (e.g., ratings or lecture reviews given to the teacher by the learners), the teacher's lecture experience and the like, as well as the teacher's level of lecture preparation or mutual expressions of respect among teachers.

Next, according to one embodiment of the invention, the learner management unit 220 may function to create a sponsorship in which at least one teacher designates at least one learner as a support recipient. Here, according to one embodiment of the invention, a teacher may designate a learner not taught by the teacher, as well as one taught by the teacher, as a support recipient of the teacher.

Further, according to one embodiment of the invention, the learner management unit 220 may function to provide a teacher who is a support provider of a sponsorship with information on a history or current state of academic achievement of a learner designated as a support recipient according to the sponsorship, and may further function to authorize the teacher being the support provider of the sponsorship to share the information on the history or current state of academic achievement of the learner being the support recipient of the sponsorship with other teachers. Further, according to one embodiment of the invention, the information on the learner's learning status provided to other teachers as above may be a lead for expressions of respect of other teachers for the teacher supporting the learner, and may also be a lead for additional sponsorships in which other teachers designates the learner as their support recipient. Further, according to one embodiment of the invention, the teacher supporting at least one learner through a sponsorship may be rewarded with a teaching condition in which the teacher may open a lecture for a relatively good lecture fee and time.

Further, according to one embodiment of the invention, the learner management unit 220 may function to allow at least one teacher to make feedback to at least one learner.

Further, according to one embodiment of the invention, the learner management unit 220 may determine an evaluation index for a learner with reference to a sponsorship or feedback for the learner. Here, according to one embodiment of the invention, the evaluation index determined for the learner may be an extrinsic evaluation index determined based on a sponsorship proposal or feedback that a teacher makes based on a learning attitude, academic achievement and the like of the learner, and may be referred to as reliability, for example.

For example, the learner management unit 220 according to one embodiment of the invention may determine an evaluation index for a first learner based on the number or size of sponsorships supporting the first learner, or feedback made to the first learner, and the first learner may be given a rating of “best learner”, “most-improved learner” or the like according to the evaluation index for the learner.

Meanwhile, according to one embodiment of the invention, the learner management unit 220 may also determine an evaluation index for a learner with reference to information on a learning attitude or academic achievement of the learner collected in learning assistance services according to the invention (i.e., commonly utilized indicators for evaluating the learner). Here, the information on the learning attitude of the learner collected in the learning assistance services may include information on a degree of compliance with learning time, a degree of achievement of learning objectives, a degree of concentration on learning, an attitude toward teachers or other learners, and the like.

Next, according to one embodiment of the invention, the reward management unit 230 may function to determine a reward or teaching condition applied to a teacher in learning assistance services according to the invention, based on an evaluation index (specifically, at least one of a first evaluation index and a second evaluation index) for the teacher determined as described above.

As an example of the teaching condition, the reward management unit 230 according to one embodiment of the invention may adjust a tuition fee of a lecture opened by a teacher such that the tuition fee may be fixed higher as a first or second evaluation index for the teacher is higher. As another example, the teacher management unit 210 according to one embodiment of the invention may dynamically adjust time for a lecture opened by a teacher with reference to a first or second evaluation index for the teacher.

As an example of the reward condition, the reward management unit 230 according to one embodiment of the invention may favorably determine a virtual money-to-cash conversion ratio applied to a teacher as a first or second evaluation index for the teacher is higher. For example, the virtual money-to-cash conversion ratio applied to a teacher B whose first or second evaluation index is up to the average may be determined as 1 to 1.1, and that applied to a teacher A whose first or second evaluation index is in the top 10 percent may be determined as 1 to 1.3.

Further, according to one embodiment of the invention, the reward management unit 230 may adaptively adjust a reward condition or learning condition (e.g., tuition fees, benefits, etc.) applied to a learner based on an evaluation index for the learner determined as described above.

Next, according to one embodiment of the invention, when know-how contents owned by a first teacher is provided to a second teacher, the reward management unit 230 may function to provide the first teacher with at least a part of virtual money currently owned or to be obtained (e.g., to be obtained in return for a lecture to be delivered over the next year) by the second teacher, as a reward for the provision of the know-how contents. Here, the teacher management unit 210 according to one embodiment of the invention may assist the first teacher to provide feedback to the second teacher or lectures of the second teacher (i.e., feedback that may be helpful to the second teacher) in return for the second teacher's provision of the virtual money to the first teacher.

Further, according to one embodiment of the invention, when a sponsorship is formed in which a first teacher designates a first learner as a support recipient, the reward management unit 230 may function to provide the first learner with at least a part of virtual money currently owned or to be obtained by the first teacher.

For example, it may be assumed that a famous piano teacher provides a sponsorship to a learner who is good at playing a piano or remarkably apt at music but in a poor household, and another teacher who recognizes excellent academic achievement of the learner also provides a sponsorship to the learner. In this case, the learner may purchase a better piano or procure school expenses to get into a music academy, by using the virtual money provided through the sponsorships.

Meanwhile, according to one embodiment of the invention, the reward management unit 230 may function to allow a teacher or learner to convert his/her own virtual money into cash.

More specifically, the reward management unit 230 according to one embodiment of the invention may adaptively adjust a virtual money-to-cash conversion ratio applied to a teacher or learner according to the period of activity in learning assistance services according to the invention. For example, the virtual money-to-cash conversion ratio applied to a learner a who has steadily learned for one year in the learning assistance services may be 1 to 1.1, and that applied to a learner b who has steadily learned for three years may be 1 to 1.3.

Meanwhile, according to one embodiment of the invention, the reward management unit 230 may function to allow a teacher not only to receive virtual money from other teachers, but also to supplement his/her virtual money by directly converting his/her cash or articles into virtual money.

Next, according to one embodiment of the invention, the database 240 may store a variety of information such as information on know-how contents owned by teachers, information on evaluation indexes of teachers, information on learning statuses of learners associated with sponsorships, information on evaluation indexes of learners, and information on virtual money owned by or provided to teachers or leaners. Although FIG. 2 shows that the database 240 is incorporated in the learning assistance system 200, the database 240 may be configured separately from the learning assistance system 200 as needed by those skilled in the art to implement the invention. Meanwhile, the database 240 according to the invention encompasses a computer-readable recording medium, and may refer not only to a database in a narrow sense but also to a database in a broad sense including file system-based data records and the like. The database 240 according to the invention may be even a collection of simple logs if one can search and retrieve data from the collection.

Next, according to one embodiment of the invention, the communication unit 250 may function to enable the learning assistance system 200 to communicate with an external device.

Lastly, according to one embodiment of the invention, the control unit 260 may function to control data flow among the teacher management unit 210, the learner management unit 220, the reward management unit 230, the database 240, and the communication unit 250. That is, the control unit 260 may control inbound data flow or data flow among the respective components of the learning assistance system 200, such that the teacher management unit 210, the learner management unit 220, the reward management unit 230, the database 240, and the communication unit 250 may carry out their particular functions, respectively.

### Embodiments

Hereinafter, various embodiments of learning assistance services that may be provided to teachers or learners by the learning assistance system 200 according to the invention will be described in detail.

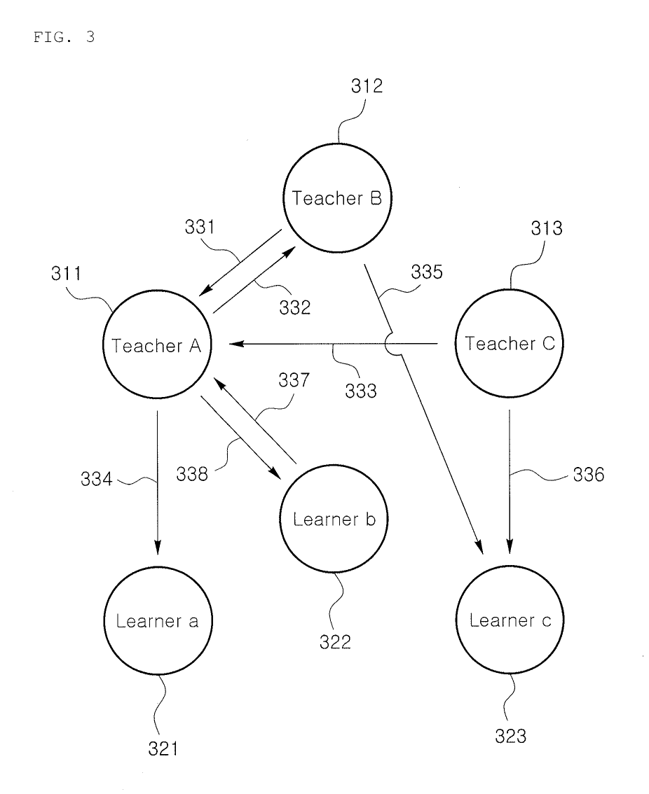

FIG. 3 illustratively shows relationships that may be formed between teachers or between learners and teachers according to one embodiment of the invention.

Referring to FIG. 3, a level of recognition of a teacher A (311) may be increased in response to a teacher B (312) expressing respect (331) for know-how contents of the teacher A (311), and the level of recognition of the teacher A (311) may be further increased in response to a teacher C (313) expressing respect (333) for the teacher A (311). Further, a level of lecture preparation of the teacher B (312) may be increased in response to the teacher B (312) receiving and acquiring (332) the know-how contents of the teacher A (311).

Referring further to FIG. 3, a sponsorship between the teacher A (311) and a learner a (321) may be created as the teacher A (311) designates the learner a (321) as a support recipient (334), and a sponsorship between the teacher B (312) and a learner c (323) may be created as the teacher B (312) designates the learner c (323) as a support recipient (335). Further, when the teacher C (313) receives information on a learning status of the learner c (323) supported by the teacher B (312) and highly regards potential for progress of the learner c (323), a sponsorship between the teacher C (313) and the learner c (323) may be further created as the teacher C (313) designates the learner c (323) as a support recipient (336).

Referring further to FIG. 3, all users may be learners and teachers at the same time. A learner b (322) may receive and acquire (338) the know-how contents of the teacher A (311) having a high level of recognition, in order to have the capacity as a teacher. Further, the learner b (322) may express respect (337) for the teacher A (311).

Meanwhile, according to one embodiment of the invention, the learning assistance system 200 may deduct at least a part of lecture fees paid by learners as commissions, and provide the remainder to teachers. At least a part of the lecture fees provided as above may be converted into a type of virtual money and transferred between teachers or between teachers and learners.

For example, it may be assumed that a teacher A is a professional lecturer who owns a large number of know-how contents, and a teacher B receives and acquires the know-how contents of the teacher A. In this case, the teacher B may provide at least a part of his/her own virtual money (which may be converted from lecture fees that the teacher B has received) to the teacher A, as a reward for the provision of the know-how contents from the teacher A. That is, the teach A may earn extra income by receiving the virtual money provided from the teacher B, and the teacher B may increase his/her level of recognition or lecture preparation owing to the know-how contents provided from the teacher A and may earn extra income as his/her lecture fees are accordingly increased in the market. Therefore, according to one embodiment of the invention, a teacher with rich experience and a high level of recognition may gain profits by passing on to (or sharing with) other teachers his/her know-how, and a teacher with poor experience and a low level of recognition may gain additional profits by learning know-how from other teachers. Therefore, the learning assistance system 200 may increase the teaching ability of all teachers who are in activity in the learning assistance services, and may give proper motivation to all the teachers.

As another example, it may be assumed that learners a and b take a lecture of a teacher A. In this case, the teacher A may make positive feedback to the learner a who unusually shows an active learning attitude or high academic achievement, and provide at least a part of his/her own virtual money to the learner a as a one-off. Further, the teacher A may designate the learner b who continuously shows an active learning attitude or high academic achievement for a predetermined period as a support recipient, thereby creating a sponsorship in which at least a part of the virtual money of the teacher A is continuously provided to the learner b. Meanwhile, the teacher A may share information on academic achievement of the learner a or b, which is provided as a reward for the provision of the virtual money to the learner a or b, with other teachers as his/her know-how contents. Thus, according to one embodiment of the invention, a learner may obtain a scholarship that may be utilized for his/her learning, by showing a positive learning attitude or attaining high academic achievement to receive virtual money from teachers, and a teacher may gain additional profits by sharing information on a positive learning attitude or high academic achievement of a learner supported by the teacher with other teachers to increase his/her level of recognition. Therefore, the learning assistance system 200 may give proper motivation to both teachers and learners who are in activity in the learning assistance services.

Meanwhile, according to one embodiment of the invention, the learning assistance system 200 may determine feedback, sponsorships, evaluation indexes, and the like per a learner group including a plurality of learners, so that proper motivation may be given to all of the plurality of learners included in the learner group. Here, according to one embodiment of the invention, the learner group may be composed of a plurality of learners having similar tastes, ages, learning levels, and the like, or a plurality of learners randomly selected without any criteria.

For example, when a sponsorship is created in which virtual money is provided to each of learners included in a learner group on condition that the attendance rate of every learner included in the learner group is 95% or more, motivation may be given in a manner, for example, in which a learner in the learner group encourages other learners to keep their attendance rates from falling (i.e., non-competitive motivation). As another example, when a goal regarding attendance rates, concentration levels, grades or the like which may be compared between groups is presented and competition between the groups is induced, motivation may be given in a manner, for example, in which a plurality of learners in a first learner group encourage each other in learning to attain better achievement than a second learner group (e.g., competitive motivation).

Meanwhile, according to one embodiment of the invention, the learning assistance system 200 may collect know-how contents owned by teachers having a level of recognition or lecture preparation equal to or higher than a predetermined level (i.e., famous teachers, professional teachers, etc.) and may use the collected know-how contents to generate a teaching manual that may be provided to teachers having a level of recognition or lecture preparation less than a predetermined level (i.e., novice teachers, etc.)

Meanwhile, the learning fields to which the learning assistance system 200 according to the invention may be applied may include mathematics, language study, and the like. However, the learning fields are not limited thereto and the learning assistance system 200 according to the invention may be applied to any knowledge that may be an object of learning regardless of subjects or fields.

The embodiments according to the invention as described above may be implemented in the form of program instructions that can be executed by various computer components, and may be stored on a non-transitory computer-readable recording medium. The non-transitory computer-readable recording medium may include program instructions, data files, data structures and the like, separately or in combination. The program instructions stored on the non-transitory computer-readable recording medium may be specially designed and configured for the present invention, or may also be known and available to those skilled in the computer software field. Examples of the non-transitory computer-readable recording medium include the following: magnetic media such as hard disks, floppy disks and magnetic tapes; optical media such as compact disk-read only memory (CD-ROM) and digital versatile disks (DVDs); magneto-optical media such as floptical disks; and hardware devices such as read-only memory (ROM), random access memory (RAM) and flash memory, which are specially configured to store and execute program instructions. Examples of the program instructions include not only machine language codes created by a compiler or the like, but also high-level language codes that can be executed by a computer using an interpreter or the like. The above hardware devices may be configured to operate as one or more software modules to perform the processes of the present invention, and vice versa.

Although the present invention has been described above in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

What is claimed is:

1. A method implemented in a learning assistance system for assisting learning, the learning assistance system comprising a teacher management unit and a reward management unit, and the method comprising the steps of:
the teacher management unit determining a first evaluation index for a teacher with reference to information on an expression of respect of at least one other teacher that is made for the teacher or know-how contents owned by the teacher, and determining a second evaluation index for the teacher with reference to information on a status of the teacher about acquirement of know-how contents owned by at least one other teacher; and
the reward management unit determining a reward or teaching condition applied to the teacher, based on at least one of the first evaluation index and the second evaluation index,
wherein the second evaluation index includes a level of lecture preparation determined based on a level at which the teacher has acquired know-how contents owned by and provided from the at least one other teacher.

2. The method of claim 1, wherein the know-how contents include at least one of video contents obtained by recording the teacher's lectures, audio contents obtained by recording the teacher's lectures, lecture notes of the teacher, memo contents created by the teacher, contents about a learning status of a learner supported by the teacher through a sponsorship, and contents about feedback provided by the teacher to lectures of the at least one other teacher.

3. The method of claim 1, wherein when a first teacher is provided with know-how contents owned by a second teacher, the reward management unit provides the second teacher with at least a part of virtual money currently owned or to be obtained by the first teacher.

4. The method of claim 1, wherein the learning assistance system further comprises a learner management unit, and
wherein when the teacher designates at least one learner as a support recipient, the learner management unit creates a sponsorship in which at least a part of virtual money currently owned or to be obtained by the teacher is provided to the at least one learner.

5. The method of claim 4, wherein when the sponsorship is created, the learner management unit authorizes the teacher to share information on a learning status of the at least one learner with other teachers.

6. The method of claim 1, wherein the learning assistance system further comprises a learner management unit, and the method further comprises the steps of:
the learner management unit determining an evaluation index for a learner with reference to information on a sponsorship or feedback for the learner; and
the reward management unit determining a reward or learning condition applied to the learner, based on the determined evaluation index.

7. A non-transitory computer-readable recording medium having stored thereon a computer program for executing the method of claim 1.

8. A system for assisting learning, comprising:
a teacher management unit configured to determine a first evaluation index for a teacher with reference to information on an expression of respect of at least one other teacher that is made for the teacher or know-how contents owned by the teacher, and to determine a second evaluation index for the teacher with reference to information on a status of the teacher about acquirement of know-how contents owned by at least one other teacher; and
a reward management unit configured to determine a reward or teaching condition applied to the teacher, based on at least one of the first evaluation index and the second evaluation index,
wherein the second evaluation index includes a level of lecture preparation determined based on a level at which the teacher has acquired know-how contents owned by and provided from the at least one other teacher.

9. The system of claim 8, wherein the know-how contents include at least one of video contents obtained by recording the teacher's lectures, audio contents obtained by recording the teacher's lectures, lecture notes of the teacher, memo contents created by the teacher, contents about a learning status of a learner supported by the teacher through a sponsorship, and contents about feedback provided by the teacher to lectures of the at least one other teacher.

10. The system of claim 8, wherein when a first teacher is provided with know-how contents owned by a second teacher, the second teacher is provided with at least a part of virtual money currently owned or to be obtained by the first teacher.

11. The system of claim 8, wherein when the teacher designates at least one learner as a support recipient, a sponsorship is created in which at least a part of virtual money currently owned or to be obtained by the teacher is provided to the at least one learner.

12. The system of claim 11, wherein when the sponsorship is created, the teacher is authorized to share information on a learning status of the at least one learner with other teachers.

13. The system of claim 8, further comprising:
a learner management unit configured to determine an evaluation index for a learner with reference to information on a sponsorship or feedback for the learner,
wherein the reward management unit determines a reward or learning condition applied to the learner, based on the determined evaluation index.
